(19) United States
(12) Patent Application Publication
(10) Pub. No.: US 2026/0360615 A1
(43) Pub. Date: Nov. 12, 2026

(54) CENTER-TAPPED ON-CHIP TRANSFORMER HAVING LOW ALTERNATING-CURRENT IMPEDANCE

(71) Applicants: JIASHAN FUDAN RESEARCH INSTITUTE, Jiaxing (CN); Fudan University, Shanghai (CN)

(72) Inventors: Yutong ZHANG, Jiaxing (CN); Kefeng HAN, Jiaxing (CN); Rui YIN, Jiaxing (CN); Hao XU, Jiaxing (CN); Na YAN, Jiaxing (CN)

(73) Assignees: JIASHAN FUDAN RESEARCH INSTITUTE, Jiaxing (CN); Fudan University, Shanghai (CN)

(21) Appl. No.: 19/129,641

(22) PCT Filed: Mar. 4, 2024
(86) PCT No.: PCT/CN2024/079887

§ 371 Date: May 13, 2025

(30) Foreign Application Priority Data
Jun. 30, 2023 (CN) 202310798000.X

(51) Int. Cl. H01F 27/34; H01F 27/29; H01F 29/02

(52) U.S. Cl. CPC H01F 27/34; H01F 27/29; H01F 29/025

(57) ABSTRACT

Provided in the present invention is a center-tapped on-chip transformer having low alternating-current impedance. The center-tapped on-chip transformer comprises a center tap, a primary coil and a secondary coil, wherein the secondary coil and the primary coil are spaced apart from each other by means of a dielectric layer; and the center tap is electrically connected to the primary coil, and comprises a power line, a capacitor cell and a ground wire, the power line being electrically connected to one end portion of the capacitor cell, and the ground wire being electrically connected to another end portion of the capacitor cell. The center-tapped on-chip transformer having low alternating-current impedance provided in the present invention reduces impedance at a center tap, and reduces parasitic inductance generated by a power line, thereby improving the performance of the transformer.

### TECHNICAL FIELD

The present invention relates to the technical field of integrated circuits, and in particular to a center-tapped on-chip transformer having low alternating-current impedance.

### BACKGROUND TECHNOLOGY

On-chip integrated transformers with center taps are often used in the design of millimeter-wave circuits, such as power amplifiers, low-noise amplifiers, mixers, frequency multipliers and other circuit modules. Transformers are often used to achieve impedance matching, single-ended-differential conversion and other functions; and introducing center taps in transformer coils can be used as power supply to provide low-impedance paths for common-mode current or provide DC bias for transistors.

In existing technical solutions, the power supply and bias are often connected to a transformer from the outside of the transformer through a long center tap wiring to power or bias circuit modules. The center tap wiring solution will introduce a large parasitic inductance, which will cause a large impedance Z to be seen at a center tap of the transformer at a certain frequency point, which is a non-ideal factor for millimeter wave circuit design and will affect the performance of the transformer.

### SUMMARY OF THE INVENTION

The present invention aims to provide a center-tapped on-chip transformer having low alternating-current impedance to reduce impedance at a center tap, and reduce parasitic inductance generated by a power line, thereby improving the performance of the transformer.

In order to achieve the above purposes, on a first aspect, the present invention provides a center-tapped on-chip transformer having low alternating-current impedance, comprising a center tap, a primary coil and a secondary coil, wherein
the secondary coil and the primary coil are spaced apart from each other by means of a dielectric layer; and
the center tap is electrically connected to the primary coil, and comprises a power line, a capacitor cell and a ground wire, wherein
the power line is electrically connected to one end portion of the capacitor cell, and the ground wire is electrically connected to another end portion of the capacitor cell.

In some embodiment, the center tap comprises M layers of metal layers stacked in sequence;

between the metal layers are arranged dielectric layers, and on the metal layers are provided via holes;
a first layer of the metal layers to a (M−2)-th layer of the metal layers are connected by electrical connection lines to form a MOM capacitor;
the power line is routed through a M-th layer of the metal layers and electrically connected to one end portion of the MOM capacitor through a corresponding via hole, and the ground wire is routed through a (M−1)-th layer of the metal layers and electrically connected to another end portion of the MOM capacitor through another corresponding via hole.

In some embodiment, both end portions of the center tap are provided with electrical lead-out terminals

In some embodiment, one end portion of the center tap is provided with an electrical lead-out terminal, and another end portion of the center tap is electrically connected to a capacitor.

In some embodiment, the center-tapped on-chip transformer having low alternating-current impedance further comprises a substrate, wherein
on a lower portion of the center-tapped on-chip transformer having low alternating-current impedance is arranged the substrate.

The center-tapped on-chip transformer having low alternating-current impedance provided by the present invention has following beneficial effects:
I. the present invention reduces parasitic inductance generated by a power line; and
II. the present invention reduces impedance at a center tap.

### BRIEF DESCRIPTION OF THE DRAWINGS

FIG. 1 is a structural schematic diagram of an on-chip transformer and a center tap in the prior art.

FIG. 2 is a schematic diagram showing equivalent parasitic inductance of a center tap in the prior art.

FIG. 3 shows curve relationships between |Z_{VDD}|, |IP3| and frequency.

FIG. 4 is a schematic diagram showing the influence of common-mode signals of a center tap on differential signals in the prior art.

FIG. 5 is a structural schematic diagram showing a single-sided powered unbalanced routing transformer in the prior art.

FIG. 6 is a structural schematic diagram showing a center-tapped on-chip transformer having low alternating-current impedance in an embodiment provided by the present invention.

FIG. 7 is a side view of the structure of a center tap having low alternating-current impedance in an embodiment provided by the present invention.

FIG. 8 shows magnetic field elimination of a return path of a power line and a ground wire.

FIG. 9 is an equivalent circuit diagram of a center tap in an embodiment provided by the present invention.

FIG. 10 is a structural schematic diagram of a center-tapped on-chip transformer having low alternating-current impedance in a single-sided power supply in an embodiment provided by the present invention.

FIG. 11 is a structural schematic diagram of a center-tapped on-chip transformer having low alternating-current impedance in another embodiment provided by the present invention.

FIG. 12 is a structural schematic diagram of a center-tapped on-chip transformer having low alternating-current impedance in a single-sided power supply in another embodiment provided by the present invention.

FIG. 13 is a comparison diagram of impedance modulus values of a Z_{VDD} of the prior art transformer and a Z_{VDD} of an on-chip transformer in the present invention at low frequencies.

The markups in the drawings are indicated as follows:
1—center tap;
2—primary coil;
3—secondary coil;
4—capacitor;
10—capacitor cell;
11—first layer of the metal layers;
12—sixth layer of the metal layers;
13—seventh layer of the metal layers;
14—eighth layer of the metal layer;
20—power line; and
30—ground wire.

### Specific Embodiments

The present invention can be implemented in different forms and should not be interpreted as being limited to the embodiments proposed herein. On the contrary, providing these embodiments will make the disclosure thorough and complete, and the scope of the present invention will be fully conveyed to those skilled in the art. In the accompanying drawings, for clarity, the size and relative size of the layers and regions may be exaggerated. The same reference numerals represent the same elements throughout. It should be understood that when an element or layer is referred to as “on”, “adjacent to”, “connected to” or “coupled to” other elements or layers, it can be directly on other elements or layers, adjacent to, connected to or coupled to other elements or layers, or there can be intervening elements or layers. On the contrary, when an element is referred to as “directly on”, “directly adjacent to”, “directly connected to” or “directly coupled to” other elements or layers, there is no intervening element or layer. It should be understood that although the terms first, second, third, etc. can be used to describe various elements, components, regions, layers and/or parts, these elements, components, regions, layers and/or parts should not be limited by these terms. These terms are only used to distinguish one element, component, region, layer or portion from another element, component, region, layer or portion. Therefore, without departing from the teachings of the present invention, a first element, component, region, layer or portion discussed below may be represented as a second element, component, region, layer or portion.

Spatially relative terms such as “under,” “below,” “below,” “under,” “above,” “above,” etc., may be used herein for ease of description to describe the relationship of an element or feature shown in the figures to other elements or features. It should be understood that the spatially relative terms are intended to include different orientations of the device in use and operation in addition to the orientations shown in the figures. For example, if the device in the drawings is turned over, then the elements or features described as “under other elements” or “under” or “under” will be oriented as “on” the other elements or features. Therefore, the exemplary terms “under” and “under” may include both upper and lower orientations. The device may be otherwise oriented (rotated 90 degrees or other orientations) and the spatial descriptors used herein are interpreted accordingly.

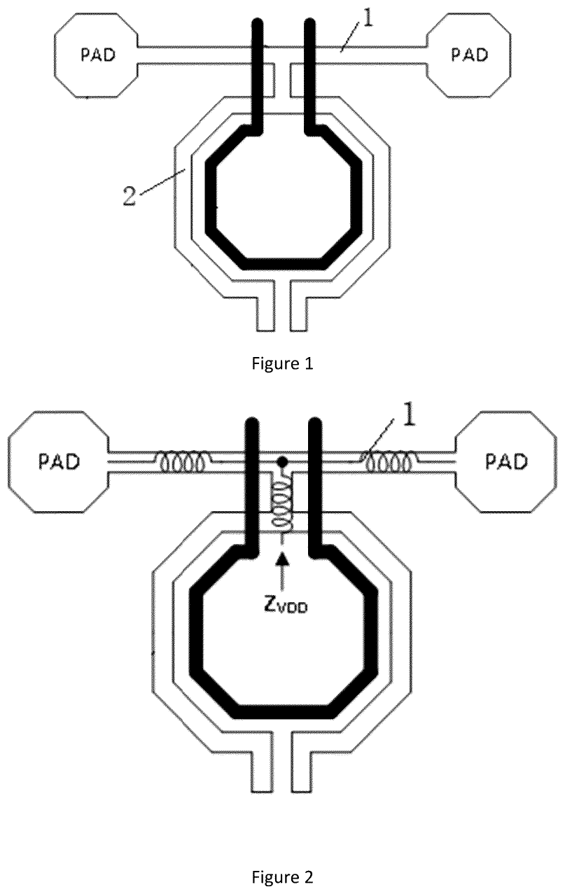

As shown in FIG. 1, power supply and bias of a conventional transformer are often connected from the outside of the transformer to a primary coil 2 on the transformer through a long routing of a center tap 1 to provide power or bias to a circuit module.

As shown in FIG. 2, a traditional routing method of a center tap 1 will introduce a large parasitic inductance, which will cause large impedance Z_{VDD} to be seen at the center tap 1 of a transformer at a certain frequency point, which will bring following adverse effects:

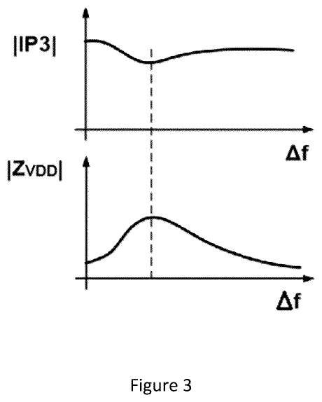

I. Introducing nonlinearity: when the center tap 1 of the transformer is connected to the power supply through a long routing, the power supply impedance Z_{VDD} it sees will affect the 3^{rd} order intermodulation point (IP3) of the circuit. As shown in FIG. 3, the modulus of Z_{VDD} is a curve that changes with frequency. At low frequencies, the parasitic inductance of the power supply trace resonates in parallel with the decoupling capacitor in the circuit, generating an impedance spike. When the dual-tone test is performed with this frequency point as the frequency interval Δf, the IP3 of the circuit will be significantly deteriorated. Moreover, as the impedance modulus at the resonance point increases, the distortion of IP3 becomes more serious. Therefore, a technical solution is needed to reduce the impedance modulus at the resonance point to improve the IP3 performance of the designed circuit at any Δf. Similarly, when the center tap 1 is connected to the bias, it also needs to be a low-impedance node, or otherwise it will cause additional nonlinearity.

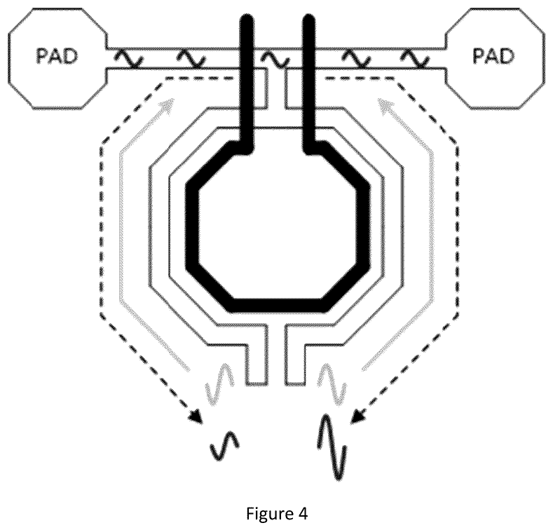

II. Reduced common-mode suppression capability of transformer: since large impedance Z_{VDD} is seen at the center tap 1, this will cause the existence of a common-mode signal at the common-mode point. As shown in FIG. 4, the external common-mode interference will be superimposed on the differential signal of the differential circuit, causing amplitude imbalance and interference with the useful signal.

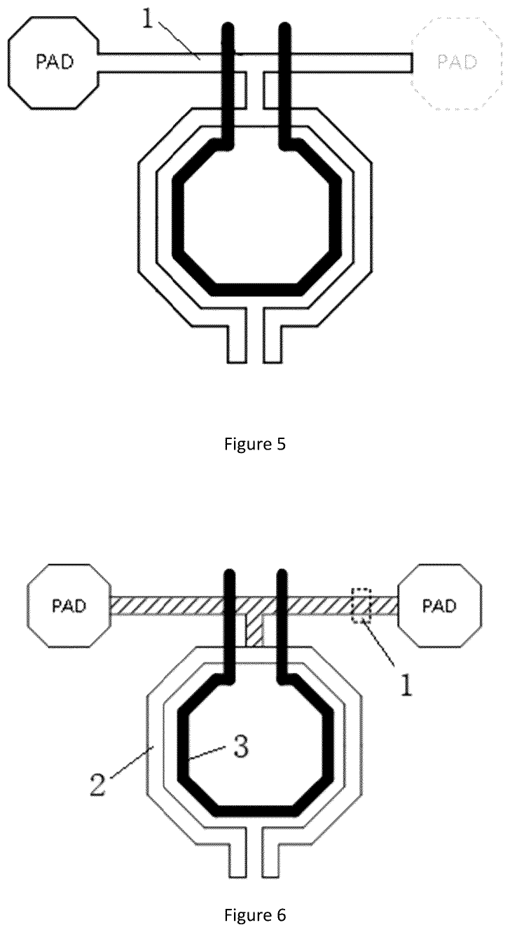

III. Impedance imbalance on both sides of the center tap 1 of single-sided power supply: when the chip area is limited or the power lead (PAD) resources are limited, the method of connecting both sides of the center tap 1 to the PAD at the same time will bring additional overhead. In this case, the structure of single-sided PAD connection is often used. As shown in FIG. 5, due to the asymmetry of the single-sided PAD structure itself, the center tap 1 wiring on one side of the PAD will have a higher electromagnetic coupling with the transformer coil, resulting in impedance imbalance on both sides of the tap, which interferes with the differential signal.

IV. Additional impact of parasitic inductance on circuit design: routing of the center tap 1 of the transformer is equivalent to a large parasitic inductance, which is a non-ideal factor for millimeter wave circuit design.

For example, in millimeter wave or even higher frequency circuits, this additional parasitic inductance is likely to affect the peak efficiency and saturated output power of the power amplifier.

As shown in FIG. 6, in order to solve the technical problems above, an embodiment of the present invention provides a center-tapped on-chip transformer having low alternating-current impedance, comprising a center tap 1, a primary coil 2 and a secondary coil 3.

Specifically, on a lower portion of the center-tapped on-chip transformer having low alternating-current impedance is arranged a substrate (which is not shown in figures).

The substrate is a semiconductor substrate, which may be a silicon substrate, a germanium substrate, a silicon-on-insulator substrate, a silicon carbide substrate, a silicon germanium substrate, a gallium nitride substrate or a glass substrate.

A dielectric layer is arranged on the primary coil 2, and the secondary coil 3 is arranged on the dielectric layer, so that the secondary coil 3 and the primary coil 2 are spaced apart by the dielectric layer.

It should be noted that the dielectric layer can usually withstand the maximum electric field at both end portions thereof. In an embodiment provided by the present invention, the dielectric layer is made of silicon oxide.

In other embodiments of the present invention, other insulating polymers and oxides (such as insulating materials commonly used in integrated circuit manufacturing) may also be used.

The center tap 1 is electrically connected to the primary coil 2, and comprises a power line 20, a capacitor cell 10 and a ground wire 30. The power line 20 is electrically connected to one end portion of the capacitor cell 10, and the ground wire 30 is electrically connected to another end portion of the capacitor cell 10.

In some embodiment, the center tap 1 comprises M layers of metal layers stacked in sequence; between the metal layers are arranged dielectric layers which can be formed by oxide materials, and on the metal layers are provided via holes; a first layer of the metal layers 11 to a (M−2)-th layer of the metal layers are connected by electrical connection lines to form a metallic oxide, MOM capacitor, namely the capacitor cell 10; the power line is routed through a M-th layer of the metal layers and electrically connected to one end portion of the MOM capacitor through a corresponding via hole, and the ground wire is routed through a (M−1)-th layer of the metal layers and electrically connected to another end portion of the MOM capacitor through another corresponding via hole.

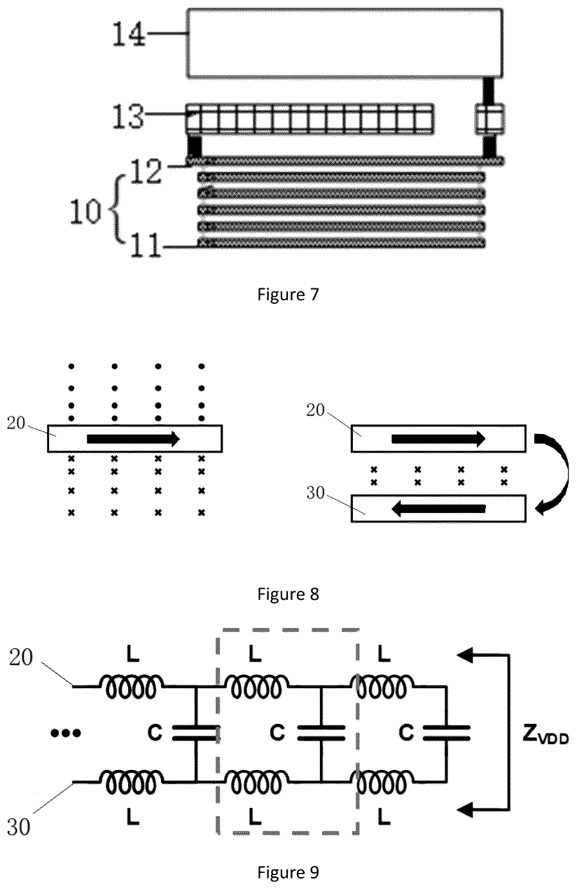

Please refer to FIG. 7, for example, when M is equal to 8, the power line 20 can be routed through an eighth metal layer of the metal layers 14, and the ground wire 30 can be routed through a seventh metal layer of the metal layers 13. At this time, each of the metal layers between a first metal layer of the metal layers 11 and a sixth metal layer of the metal layers 12 can form the MOM capacitor by passing the electrical connection line through corresponding via holes.

The via hole provided on the seventh metal layer of the metal layers 13 described in the seventh layer is defined as a seventh via hole, and similarly, a via hole provided on the sixth metal layer of the metal layers 12 described in a sixth layer is defined as a sixth via hole. The power line 20 can be electrically connected to one end portion of the MOM capacitor through the seventh via hole and the sixth via hole, and the ground wire 30 can be electrically connected to another end portion of the MOM capacitor through the sixth via hole, so as to achieve coupling between the power line 20 and the ground wire 30 through the MOM capacitor.

In some embodiments, a layer of the ground wire 30 is laid under the power line 20, and the capacitor cell 10 is introduced between the power line 20 and the ground wire 30, so that the power supply impedance can be reduced.

Please refer to FIG. 8, it can be understood that laying a layer of the ground wire 30 near the power line 20 can form a current return path. The current directions of the power line 20 and the ground wire 30 are opposite, which plays a role in eliminating the magnetic field and significantly reduces the parasitic inductance of the power line 20.

As shown in FIG. 9, the equivalent model of the capacitor cell 10 is similar to the lumped parameter model of the transmission line, namely

$${Z}_{VDD} \approx \sqrt{\frac{L}{C}} ,$$

but different from the transmission line, the capacitor in each capacitor cell 10 is additionally introduced. By adding a large MOM capacitor, small impedance can be seen from the center tap 1.

As shown in FIG. 10, in some embodiments, one end portion of the center tap 1 is provided with an electrical lead-out terminal (PAD), and another end portion of the center tap 1 is electrically connected to a capacitor 4. The center tap 1 can also be used for such unbalanced wiring with single-side power supply. The center tap 1 does not need to place PADs on both ends of the transformer to maintain impedance balance. By adding a very small capacitor 4 on an unbalanced side, the impedance on both sides can be made very low, approximately the AC ground, which saves PAD resources and reduces chip area, while the common mode impedance seen by the center tap 1 is still very low.

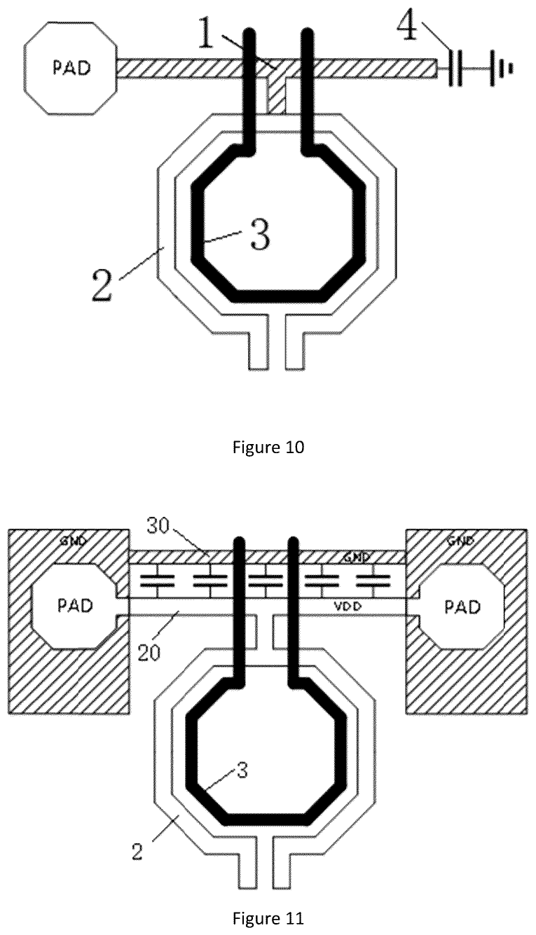

Please refer to FIG. 11, in some embodiments, for an on-chip transformer with a center tap 1 with low AC impedance and PAD power supply on both sides, a ground wire 30 can be laid directly in parallel on the outside of the power line 20 at the center tap, and then a MOM capacitor can be connected between the power line 20 and the ground wire 30.

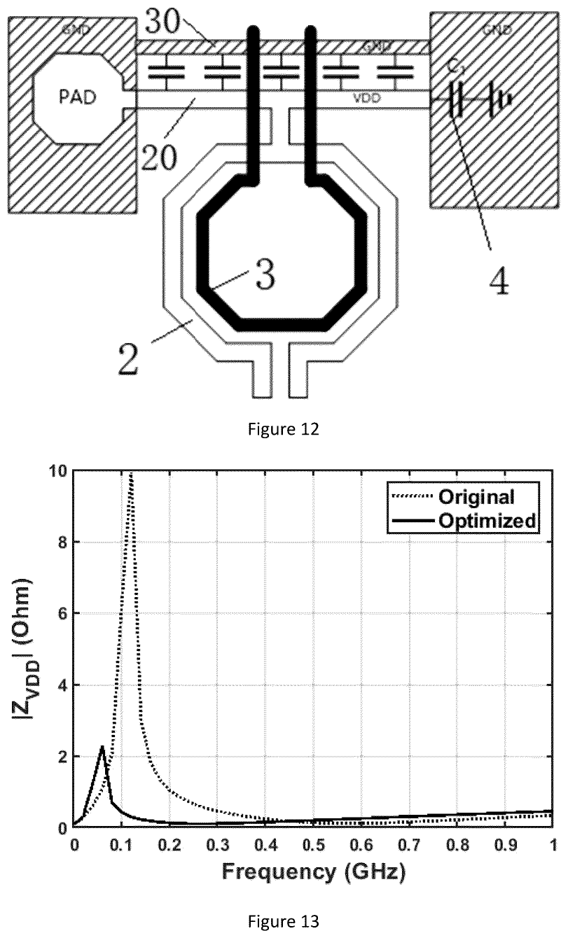

Please refer to FIG. 12, in some embodiments, similarly, for an on-chip transformer with a center tap 1 having low AC impedance powered by a single-sided PAD, a capacitor 4 is connected on another side, and then a ground wire 30 can be laid directly under the routing of the power line 20 at the center tap, or a ground wire 30 can be laid in parallel on the outside of the center tap, and a MOM capacitor is connected between the power line 20 and the ground wire 30.

It should be noted that, in the present embodiment, MOM capacitors are used. In fact, multiple types of capacitors can be used or mixed as alternatives, such as MOS capacitors, varactor capacitors, and MIM capacitors, so that the capacitor density is higher and the impedance of the center tap 1 can be further reduced.

As shown in FIG. 13, in the solution where the power supply is directly connected to the center tap 1, the maximum impedance modulus value of Z_{VDD} at low frequency is about 10 ohm, while after the solution proposed in the present invention is optimized, the peak value of Z_{VDD} near 50 MHz is about 2 ohm, the impedance modulus value is significantly reduced, and the linearity is significantly improved.

Although the embodiments of the present invention are described in detail above, it is obvious to those skilled in the art that various modifications and variations can be made to these embodiments. However, it should be understood that such modifications and variations are within the scope and spirit of the present invention as described in the claims. Moreover, the present invention described herein may have other embodiments and may be implemented or realized in a variety of ways.

1. A center-tapped on-chip transformer having low alternating-current impedance, comprising a center tap, a primary coil and a secondary coil, wherein
the secondary coil and the primary coil are spaced apart from each other by means of a dielectric layer; and
the center tap is electrically connected to the primary coil, and comprises a power line, a capacitor cell and a ground wire, wherein
the power line is electrically connected to one end portion of the capacitor cell, and the ground wire is electrically connected to another end portion of the capacitor cell.

2. The center-tapped on-chip transformer having low alternating-current impedance according to claim 1, wherein the center tap comprises M layers of metal layers stacked in sequence;
between the metal layers are arranged dielectric layers, and on the metal layers are provided via holes;
a first layer of the metal layers to a (M−2)-th layer of the metal layers are connected by electrical connection lines to form a MOM capacitor; and
the power line is routed through a M-th layer of the metal layers and electrically connected to one end portion of the MOM capacitor through a corresponding via hole, and the ground wire is routed through a (M−1)-th layer of the metal layers and electrically connected to another end portion of the MOM capacitor through another corresponding via hole.

3. The center-tapped on-chip transformer having low alternating-current impedance according to claim 2, wherein both end portions of the center tap are provided with electrical lead-out terminals

4. The center-tapped on-chip transformer having low alternating-current impedance according to claim 2, wherein one end portion of the center tap is provided with an electrical lead-out terminal, and another end portion of the center tap is electrically connected to a capacitor.

5. The center-tapped on-chip transformer having low alternating-current impedance according to claim 1, wherein the power line and the ground wire are arranged side by side in parallel, and the capacitor cell is located between the power line and the ground wire and is electrically connected to the power line and the ground wire.

6. The center-tapped on-chip transformer having low alternating-current impedance according to claim 1, further comprising a substrate; wherein the center-tapped on-chip transformer having low alternating-current impedance is arranged on the substrate.
